(19) United States
(12) Patent Application Publication
(10) Pub. No.: US 2022/0067019 A1
(43) Pub. Date: Mar. 3, 2022

(54) DATA COOPERATION SYSTEM AND CONTROL SYSTEM

(71) Applicant: KYOCERA Document Solutions Inc., Osaka-shi (JP)

(72) Inventor: Koki Nakajima, Osaka-shi (JP)

(21) Appl. No.: 17/408,585

(22) Filed: Aug. 23, 2021

(30) Foreign Application Priority Data
Aug. 26, 2020 (JP) 2020-142894

(51) Int. Cl. G06F 16/23; G06F 16/25; G06F 16/21; G06F 8/65

(52) U.S. Cl. CPC G06F 16/2358; G06F 8/65; G06F 16/21; G06F 16/258

(57) ABSTRACT

A data cooperation system includes a data collection system that collects data held by an information system, a data storage system that stores data collected by the data collection system, and a pipeline orchestrator that updates the data storage system in response to a change in data format of the information system.

### INCORPORATION BY REFERENCE

This application is based upon, and claims the benefit of priority from, corresponding Japanese Patent Application No. 2020-142894 filed in the Japan Patent Office on Aug. 26, 2020, the entire contents of which are incorporated herein by reference.

### BACKGROUND

### Field of the Invention

The present disclosure relates to a data cooperation system for collecting and storing data held by an information system, and also relates to a control system.

### Description of Related Art

A typical technique to achieve proper data synchronization in different network environments has been known.

### SUMMARY

A data cooperation system of the present disclosure includes a data collection system that collects data held by an information system, a data storage system that stores data collected by the data collection system, and a control system that updates the data storage system in response to a change in data format of the information system.

The control system of the present disclosure updates the data storage system, which stores data collected by the data collection system collecting data held by the information system, in response to the change in data format of the information system.

### BRIEF DESCRIPTION OF THE DRAWINGS

FIG. 1 is a block diagram of a system according to an embodiment of the present disclosure;

FIG. 2 is a block diagram of the pipeline provided in a data storage system illustrated in FIG. 1;

FIG. 3 is an illustration of information managed by a configuration management server of FIG. 1;

FIG. 4 is an illustration of information managed by a pipeline orchestrator of FIG. 1;

FIG. 5 is a sequence diagram illustrating the operation of the system to update a big data analysis unit by a control service unit by periodically checking for a change in data format of the information system;

FIG. 6 illustrates an “update” sequence of FIG. 5; and

FIG. 7 is a sequence diagram illustrating the operation of the data cooperation system of FIG. 1 to update the big data analysis unit by entering an update program into a configuration management gateway.

### DETAILED DESCRIPTION

An embodiment of the present disclosure will be described below with reference to the accompanying drawings.

First, the structure of a system according to the embodiment of the present disclosure is described.

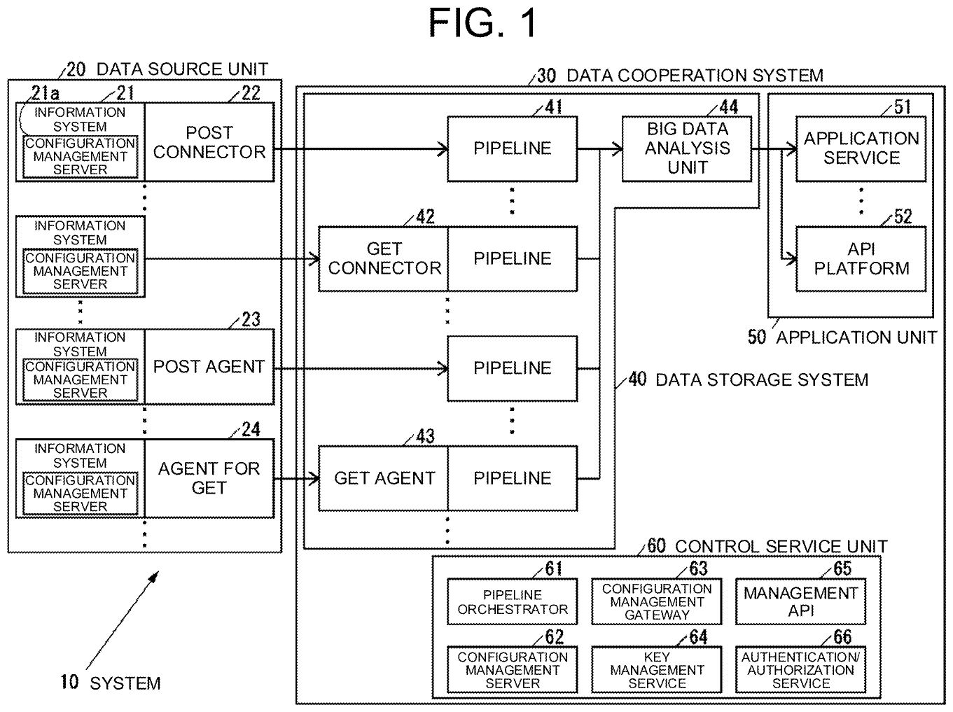

FIG. 1 is a block diagram of a system 10 according to the present embodiment.

As illustrated in FIG. 1, the system 10 includes a data source unit 20 that generates data and a data cooperation system 30 that performs data cooperation of the data generated by the data source unit 20.

The data source unit 20 includes an information system 21 that generates data. The information system 21 includes a configuration management server 21a that saves the configuration and settings of the information system 21. The data source unit 20 may also include at least one information system other than the information system 21. Examples of the information system include

an Internet of Things (IoT) system such as a remote management system for remotely managing the image forming apparatus, e.g., a multifunction peripheral (MFP) or a printer, and an in-house system such as an enterprise resource planning (ERP) system or a production management system. Each information system may be constituted by one computer or by a plurality of computers. Each information system may be built on a public cloud. The information system may hold structured data files. The information system may hold unstructured data files. The information system may hold a database of structured data.

The data source unit 20 includes a POST connector 22 as a data collection system that retrieves the structured or unstructured data files held by the information system and transmits the retrieved files to a pipeline, which will be described later, of the data cooperation system 30. The data source unit 20 may also include at least one POST connector having the same configuration as the POST connector 22 other than the POST connector 22. The POST connector may be constituted by a computer that implements the information system in which the POST connector itself retrieves files. The POST connector is also a constituting component of the data cooperation system 30.

The data source unit 20 includes a POST agent 23 as a data collection system that retrieves structured data from a database of the structured data held by the information system and transmits the retrieved structured data to a pipeline, which will be described later, of the data cooperation system 30. The data source unit 20 may also include at least one POST agent having the same configuration as the POST agent 23 other than the POST agent 23. The POST agent may be constituted by a computer that implements the information system in which the POST agent itself retrieves the structured data. The POST agent is also a constituting component of the data cooperation system 30.

The data source unit 20 includes an agent for GET 24 as a data collection system that generates the structured data for data cooperation in accordance with the data held by the information system. The data source unit 20 may also include at least one GET agent having the same configuration as the agent for GET 24 other than the agent for GET 24. The GET agent may be constituted by a computer that implements the information system holding the data from which the structured data for data cooperation is generated. The GET agent is also a constituting component of the data cooperation system 30.

The data cooperation system 30 includes a data storage system 40 that stores data generated by the data source unit 20, an application unit 50 that uses the data stored in the data storage system 40, and a control service unit 60 functioning as a control system that executes various kinds of control processing for the data storage system 40 and the application unit 50.

The data storage system 40 includes a pipeline 41 that stores the data generated by the data source unit 20. The data storage system 40 may also include at least one pipeline other than the pipeline 41. Since the data configuration of the information system may be different for each information system, the data storage system 40 basically includes a pipeline for each information system. Each pipeline may be constituted by one computer or by a plurality of computers.

The data storage system 40 includes a GET connector 42 as the data collection system that retrieves the structured or unstructured data files held by the information system and performs cooperation of the retrieved files in the pipeline. The data storage system 40 may also include at least one GET connector having the configuration similar to that of the GET connector 42 other than the GET connector 42. The GET connector may be constituted by a computer that implements the pipeline in which the GET connector itself performs cooperation of files.

The system 10 includes the POST connector in the data source unit 20 for the information system that does not support retrieval of structured or unstructured data files from the data storage system 40 side. On the other hand, the system 10 includes the GET connector in the data storage system 40 for the information system that supports retrieval of structured or unstructured data files from the data storage system 40 side.

The data storage system 40 includes a GET agent 43 as the data collection system that retrieves structured data generated by the GET agent and performs cooperation of the retrieved structured data in the pipeline. The data storage system 40 may also include at least one GET agent having the same configuration as the GET agent 43 other than the GET agent 43. The GET agent may be constituted by a computer that implements the pipeline in which the GET agent itself performs cooperation of structured data.

The system 10 includes the POST agent in the data source unit 20 for the information system that does not support retrieval of the structured data from the data storage system 40 side. On the other hand, the system 10 includes the GET agent in the data source unit 20 and the GET agent in the data storage system 40 for the information system that supports the retrieval of the structured data from the data storage system 40 side.

The data storage system 40 includes a big data analysis unit 44 as a data conversion system that executes final conversion processing as data conversion processing for converting data stored in a plurality of pipelines into a form capable of being searched or aggregated with a query language or a database language such as the Structured Query Language (SQL). The big data analysis unit 44 can also execute search or aggregation in response to a request of search or aggregation from the application unit 50 side with respect to the data having been undergone the final conversion processing. The big data analysis unit 44 may be constituted by one computer or by a plurality of computers.

The final conversion processing may include data integration processing for integrating data of a plurality of information systems as data conversion processing. In a case where the system 10 includes, as information systems, a remote management system located in Asia to remotely manage a large number of image forming apparatuses located in Asia, a remote management system located in Europe to remotely manage a large number of image forming apparatuses located in Europe, and a remote management system located in North America to remotely manage a large number of image forming apparatuses located in North America, the three remote management systems each include a device management table that manages the image forming apparatuses managed by each remote management system. The device management table shows information indicating various kinds of information of each image forming apparatus by correlating each information to an ID. Since each of the three remote management systems has a unique device management table, the same ID may be assigned to different image forming apparatuses between the device management tables of the three remote management systems. Therefore, when the big data analysis unit 44 integrates the device management tables of the three remote management systems to generate one device management table, the ID is reassigned to each image forming apparatus to prevent duplication.

The application unit 50 includes an application service 51 that uses the data managed by the big data analysis unit 44 to execute a specific operation instructed by the user, such as display of data and analysis of data. The application unit 50 may also include at least one application service other than the application service 51. Each application service may be constituted by one computer or by a plurality of computers. Examples of the application service include a business intelligence (BI) tool and a Software as a Service (SaaS) server.

The application unit 50 includes an API platform 52 that provides an application program interface (API) that executes a specific operation using the data managed by the big data analysis unit 44. The API platform 52 may be constituted by one computer or by a plurality of computers. The API provided by the API platform 52 may be invoked by a system external to the system 10, such as the BI tool or the SaaS server, or by an application service of the application unit 50. The API provided by the API platform 52 is the API for retrieving, from the data storage system 40, the data based on the data stored in the data storage system 40. For example, the APIs provided by the API platform 52 include: an API for transmitting data on the remaining amount of consumables collected from the image forming apparatus by the remote management system to a consumables ordering system external to the system 10, which orders consumables when the remaining amount of consumables such as toner in the image forming apparatus is less than a specific amount; an API for transmitting various kinds of data collected from the image forming apparatus by the remote management system to a failure prediction system external to the system 10, which predicts failures of the image forming apparatus; an API for transmitting counter information indicating the number of printed copies collected from the image forming apparatus by the remote management system to a system external to the system 10; an API for transmitting data indicating the usage status of users of the system 10 to a system external to the system 10; and an API for accepting a search query for retrieving certain data based on the data managed by the system 10.

The control service unit 60 includes a pipeline orchestrator 61 as a processing monitoring system for monitoring each stage of processing of the data in the data source unit 20, the data storage system 40, and the application unit 50. The pipeline orchestrator 61 may be constituted by one computer or by a plurality of computers.

The control service unit 60 includes a configuration management server 62 that saves the configuration and settings of the data storage system 40 and automatically performs deployment as needed. The configuration management server 62 may be constituted by one computer or by a plurality of computers.

The control service unit 60 includes a configuration management gateway 63 connected to the configuration management server of the information system and collects information for detecting a change in the configuration of the database or the unstructured data of the information system, that is, a change in the data configuration of the information system. The configuration management gateway 63 may be constituted by one computer or by a plurality of computers.

The control service unit 60 includes a Key management service 64 that encrypts and stores security information such as key information and connecting character strings required for cooperation between the systems such as the information systems. The Key management service 64 may be constituted by one computer or by a plurality of computers.

The control service unit 60 includes a management API 65 that receives requests from the data storage system 40 and the application unit 50. The management API 65 may be constituted by one computer or by a plurality of computers.

The control service unit 60 includes an authentication/authorization service 66 that executes authentication/authorization of the application service of the application unit 50. The authentication/authorization service 66 may be constituted by one computer or by a plurality of computers. The authentication/authorization service 66 can check, for example, whether the application service is permitted to request the update of the data of the information system stored in the data storage system 40.

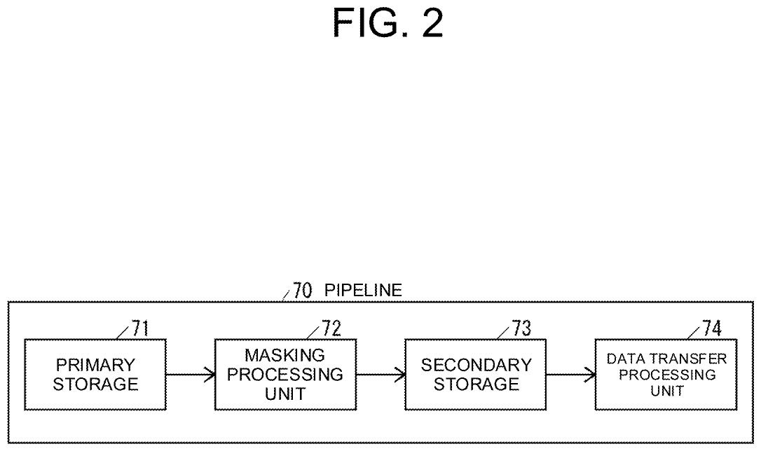

FIG. 2 is a block diagram of a pipeline 70 included in the data storage system 40.

As illustrated in FIG. 2, the pipeline 70 includes: a primary storage 71 having a storage area for storing data received from the POST connector, the POST agent, the GET connector, or the GET agent; a masking processing unit 72 that executes masking processing on privacy-related data such as personal information of users of the information system among the data stored in the primary storage 71, a secondary storage 73 having a storage area for storing data having been undergone the masking processing by the masking processing unit 72, and a data transfer processing unit 74 that executes data transfer processing to transfer the data stored in the secondary storage 73 to the big data analysis unit 44 (see FIG. 1). The primary storage 71 is provided to allow re-execution of failed processing, if the processing fails in the step of, for example, the masking processing or the data transfer processing during data processing following the step of storing the data in the primary storage 71, by using the data stored in the primary storage 71 and not using retransmission of the data, which requires a high network communication cost, from the data source unit 20 to the data cooperation system 30.

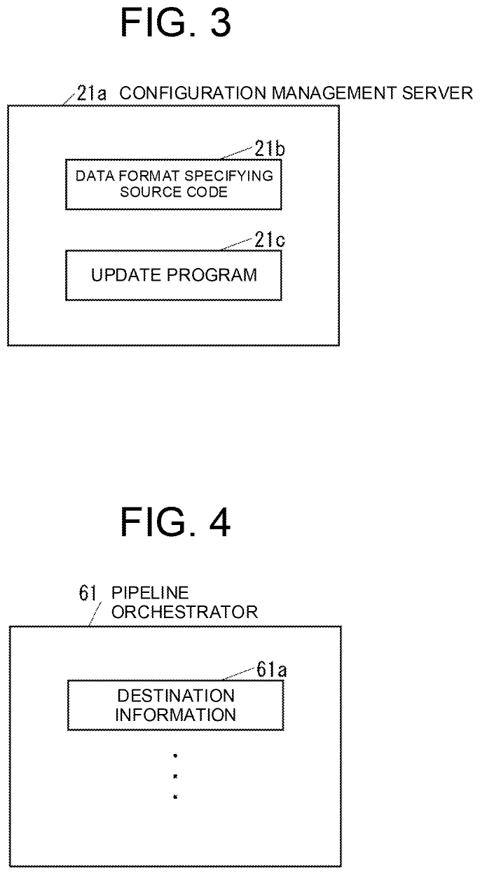

FIG. 3 is an illustration of information managed by the configuration management server 21a.

As illustrated in FIG. 3, the configuration management server 21a can manage a source code that specifies the data format of the information system 21 (hereinafter referred to as the “data format specifying source code”) 21b, and a program for updating the big data analysis unit 44 (hereinafter referred to as the “update program”) 21c to cause the big data analysis unit 44 to correspond to the data format specifying source code 21b. The data format specifying source code 21b and the update program 21c are created by, for example, the developer of the information system 21 and managed by the configuration management server 21a. The information system 21 generates data in the format specified by the data format specifying source code 21b by executing the data format specifying source code 21b managed by the configuration management server 21a.

FIG. 4 illustrates the information managed by the pipeline orchestrator 61.

As illustrated in FIG. 4, the pipeline orchestrator 61 can manage destination information 61a that indicates the notifying address of an error mail, which is an email to urge preparation of the update program corresponding to the data format specifying source code. The pipeline orchestrator 61 can also manage at least another piece of destination information other than the destination information 61a. The pipeline orchestrator 61 can manage the destination information for each information system. The destination information includes, for example, a destination address of the administrator of the data cooperation system 30, a destination address of the administrator of the information system, and a destination address of the developer of the information system. The destination information can be set by, for example, the administrator of the data cooperation system 30.

Next, the operation of the system 10 to update the big data analysis unit 44 by the control service unit 60 by periodically checking for a change in data format of the information system is described.

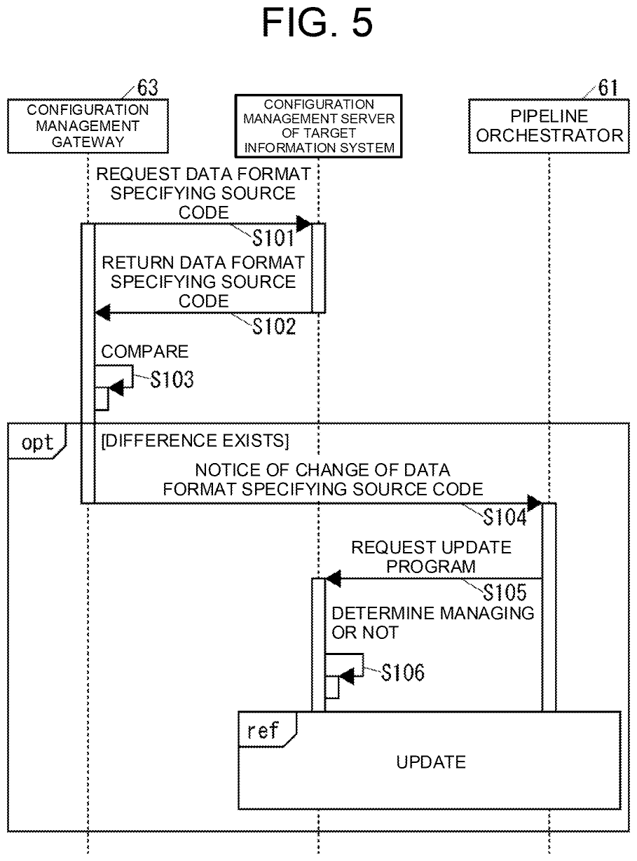

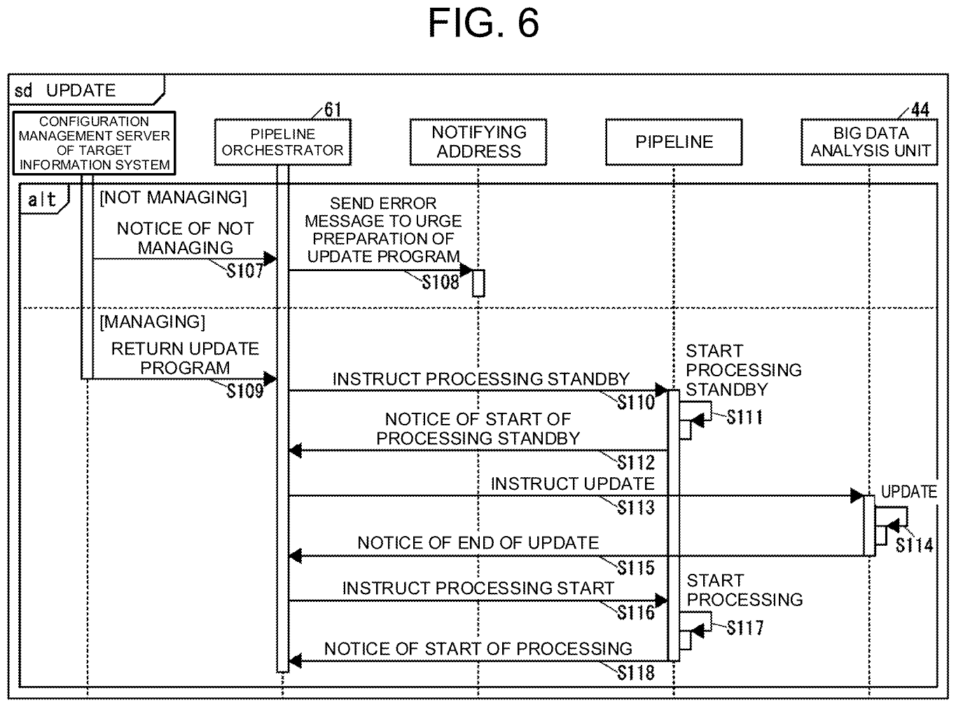

FIG. 5 is a sequence diagram illustrating the operation of the system 10 to update the big data analysis unit 44 by the control service unit 60 by periodically checking for a change in data format of the information system. FIG. 6 is a diagram illustrating the “update” sequence of FIG. 5.

The configuration management gateway 63 performs the operations illustrated in FIGS. 5 and 6 for each information system at specific intervals, such as once an hour or once every half day. The interval at which the configuration management gateway 63 executes the operations illustrated in FIGS. 5 and 6 can be set by, for example, the administrator of the data cooperation system 30.

As illustrated in FIGS. 5 and 6, the configuration management gateway 63 requests the data format specifying source code of an intended information system (hereinafter referred to as the “target information system”) to the configuration management server of the target information system (S101).

Upon receipt of the request in S101, the configuration management server of the target information system returns the target data format specifying source code requested in S101 to the configuration management gateway 63 (S102).

Upon receipt of the response in S102, the configuration management gateway 63 compares the data format specifying source code currently returned in S102 with the data format specifying source code returned last time in S102 (S103). Instead of comparing the code itself of the data format specifying source code currently returned in S102 with the code itself of the data format specifying source code returned last time in S102, the configuration management gateway 63 may compare the data format specifying source code currently returned in S102 with the data format specifying source code returned last time in S102. For example, in a case where there is a difference between the time stamp of the data format specifying source code currently returned in S102 and the time stamp of the data format specifying source code returned last time in S102, the configuration management gateway 63 can determine in S103 that the difference exists between the data format specifying source code currently returned in S102 and the data format specifying source code returned last time in S102. Alternatively, if there is a difference between a hash value of the data format specifying source code currently returned in S102 and a hash value of the data format specifying source code returned last time in S102, the configuration management gateway 63 may determine in S103 that the difference exists between the data format specifying source code currently returned in S102 and the data format specifying source code returned last time in S102.

When the configuration management gateway 63 determines in S103 that the data format specifying source code currently returned in S102 is identical to the data format specifying source code returned last time in S102, the operations illustrated in FIGS. 5 and 6 are ended.

When the configuration management gateway 63 determines in S103 that the difference exists between the data format specifying source code currently returned in S102 and the data format specifying source code returned last time in S102, the configuration management gateway notifies the pipeline orchestrator 61 of the change in the data format specifying source code of the target information system (S104).

Upon receipt of the notice in S104, the pipeline orchestrator 61 requests for an update program corresponding to the notice of change in S104 to the configuration management server of the target information system (S105). The pipeline orchestrator 61 may include, in the request in S105, identification information (hereinafter referred to as the “source code ID”) of the data format specifying source code currently returned to the configuration management gateway 63 from the configuration management server of the target information system in S102.

Upon receipt of the request in S105, the configuration management server of the target information system determines whether it manages the update program for the target of the request in S105 (S106). For example, if the update program itself includes the source code ID of the data format specifying source code corresponding to the update program, and the configuration management server of the target information system manages the update program including the source code ID included in the request in S105, then the configuration management server can determine that it manages the target update program requested in S105.

When the configuration management server of the target information system determines in S106 that it does not manage the target update program requested in S105 in S106, the configuration management server notifies the pipeline orchestrator 61 of not managing the requested target update program (S107).

Upon receipt of the notice in S107, the pipeline orchestrator 61 sends an error mail to the notifying address indicated by the destination information to urge preparation of the update program corresponding to the data format specifying source code (S108).

When the configuration management server of the target information system determines in S106 that it manages the target update program requested in S105, the configuration management server returns the target update program requested in S105 to the pipeline orchestrator 61 (S109).

Upon receipt of the response in S109, the pipeline orchestrator 61 instructs the pipeline corresponding to the target information system to stand by for processing of the data generated by the data source unit 20 (S110).

Upon receipt of the instruction in S110, the pipeline starts processing standby of the data generated by the data source unit 20 (S111) and notifies the pipeline orchestrator 61 of the start of the processing standby of the data generated by the data source unit 20 (S112).

Upon receipt of the notice in S112, the pipeline orchestrator 61 instructs the big data analysis unit 44 to update using the update program returned from the configuration management server of the target information system in S109 (S113). The pipeline orchestrator 61 includes the update program returned from the configuration management server of the target information system in S109 in the instruction in S113.

Upon receipt of the instruction in S113, the big data analysis unit 44 updates the big data analysis unit 44 itself using the update program included in the instruction in S113 (S114). In other words, the big data analysis unit 44 performs migration. Thus, the big data analysis unit 44 can reduce the possibility of failure in reading data from the pipeline caused by, for example, the change in the data format of the information system.

After the processing in S114, the big data analysis unit 44 notifies the pipeline orchestrator 61 of the end of the update (S115).

Upon receipt of the notice in S115, the pipeline orchestrator 61 instructs the pipeline corresponding to the target information system to start processing the data generated by the data source unit 20 (S116).

Upon receipt of the instruction in S116, the pipeline starts processing the data generated by the data source unit 20 (S117) and notifies the pipeline orchestrator 61 of the start of processing the data generated by the data source unit 20 (S118).

The operation of the system 10 has been described above, in which the control service unit 60 periodically checks for the change in the data format of the information system to update the big data analysis unit 44. Instead of periodically checking for the change in the data format of the information system by the control service unit 60, the update of the big data analysis unit 44 may be executed by entering the update program into the configuration management gateway 63.

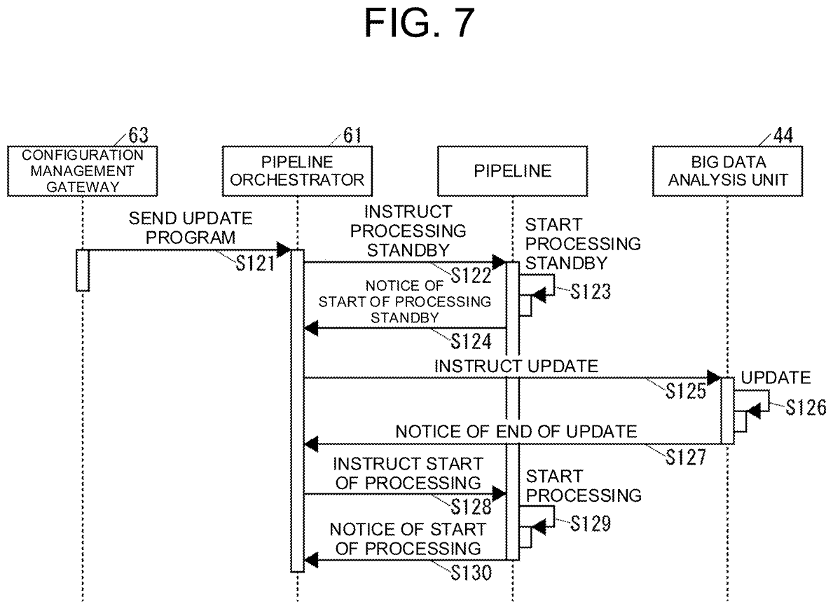

FIG. 7 is a sequence diagram illustrating the operation of the data cooperation system 30 to update the big data analysis unit 44 by entering the update program into the configuration management gateway 63.

The developer of the information system allows the configuration management server of the information system to manage a new data format specifying source code, while entering the update program corresponding to the data format specifying source code into the configuration management gateway 63 as the update program corresponding to the information system. Entering the update program into the configuration management gateway 63 is executed by setting the update program in the interface provided by the configuration management gateway 63.

When the update program is entered, the configuration management gateway 63 transmits the update program to the pipeline orchestrator 61, as illustrated in FIG. 7 (S121).

Upon receipt of the update program transmitted in S121, the pipeline orchestrator 61 instructs the pipeline corresponding to the information system related to the update program transmitted in S121, that is, the target information system, to stand by for processing of the data generated by the data source unit 20 (S122).

Upon receipt of the instruction in S122, the pipeline starts processing standby of the data generated by the data source unit 20 (S123), and notifies the pipeline orchestrator 61 of the start of the processing standby of the data generated by the data source unit 20 (S124).

Upon receipt of the notice in S124, the pipeline orchestrator 61 instructs the big data analysis unit 44 to execute the update using the update program transmitted from the configuration management gateway 63 in S121 (S125). The pipeline orchestrator 61 includes the update program transmitted from the configuration management gateway 63 in S121 in the instruction in S125.

Upon receipt of the instruction in S125, the big data analysis unit 44 updates the big data analysis unit 44 itself using the update program included in the instruction of S125 (S126). In other words, the big data analysis unit 44 performs migration. Thus, the big data analysis unit 44 can reduce the possibility of failure in reading data from the pipeline caused by, for example, the change in the data format of the information system.

After the processing in S126, the big data analysis unit 44 notifies the pipeline orchestrator 61 of the end of the update (S127).

Upon receipt of the notice in S127, the pipeline orchestrator 61 instructs the pipeline corresponding to the target information system to start processing the data generated by the data source unit 20 (S128).

Upon receipt of the instruction in S128, the pipeline starts processing the data generated by the data source unit 20 (S129) and notifies the pipeline orchestrator 61 of the start of processing the data generated by the data source unit 20 (S130).

As described in the above, the data cooperation system 30 can update the data storage system 40 in response to the change in the data format of the information system (S113 or S125).

The data cooperation system 30 accesses the information system to automatically check whether the data format of the information system has been changed (S101 to S103), thus responding efficiently to the change in the data format of the information system.

When the data cooperation system 30 detects the change in the data format of the information system, the data cooperation system 30 retrieves the update program corresponding to the detected change, from the information system (S105 and S109), and updates the data storage system 40 using the retrieved update program (S113). This enables the automatic update of the data storage system 40 corresponding to the change in the data format of the information system, and allows the system to efficiently respond to the change in the format of the data of the information system.

When the data cooperation system 30 detects the change in the data format of the information system and no update program corresponding to the detected change exists in the information system, the data cooperation system 30 executes notification to urge preparation of the update program (S108) to allow the system to efficiently respond to the change in the data format of the information system.

When the data cooperation system 30 receives the update program corresponding to the change in the data format of the information system, the data cooperation system 30 updates the data storage system 40 using the received update program (S125), and allows the system to efficiently respond to the change in the data format of the information system.

What is claimed is:

1. A data cooperation system, comprising:
a data collection system that collects data held by an information system;
a data storage system that stores data collected by the data collection system; and
a control system that updates the data storage system in response to a change in data format of the information system.

2. The data cooperation system according to claim 1, wherein
the control system accesses the information system to automatically check whether the change has been performed.

3. The data cooperation system according to claim 2, wherein
when the control system detects the change, the control system retrieves, from the information system, an update program corresponding to the change, and updates the data storage system using the retrieved update program.

4. The data cooperation system according to claim 3, wherein
when the control system detects the change and no update program corresponding to the change exists in the information system, the control system executes notification to urge preparation of the update program.

5. The data cooperation system according to claim 1, wherein
when the control system receives the update program corresponding to the change, the control system updates the data storage system using the received update program.

6. A control system that updates a data storage system, which stores data collected by a data collection system collecting data held by an information system, in response to a change in data format of the information system.
